(19) United States
(12) Patent Application Publication
(10) Pub. No.: US 2023/0096372 A1
(43) Pub. Date: Mar. 30, 2023

(54) LOCALIZED AUTHORIZATION FOR SECURE COMMUNICATION

(71) Applicant: AT&T Intellectual Property I, L.P., Atlanta, GA (US)

(72) Inventor: Wei Wang, Harrison, NJ (US)

(21) Appl. No.: 17/485,773

(22) Filed: Sep. 27, 2021

(51) Int. Cl. H04L 29/06

(52) U.S. Cl. CPC H04L 63/0428

(57) ABSTRACT

A system for localized authorization for secure communication may include sending a request to provide authorization of local communication for one or more devices to use a data service. The one or more devices may be determined based on a location proximate to the apparatus. A device may request resources on behalf of one or more devices upon successful authentication of itself. A system can provide a one-time or temporary agreement after multiple devices agree on a contract upon authenticating with the network.

### BACKGROUND

Zenkey or similar technology may be used for simple authentication with a 3rd party without signup. The cloud checks whether the user is who he claims to be and if he is, then certain information may be passed to the 3rd party. This authentication technology may be used to simplify authentication process after signup. The technology may provide traceability to a user without giving the 3rd party identity information of a user.

This background information is provided to reveal information believed by the applicant to be of possible relevance. No admission is necessarily intended, nor should be construed, that any of the preceding information constitutes prior art.

### SUMMARY

A system provides for streamlined localized authorization for secure communication. In an example, an apparatus may include a processor and a memory coupled with the processor that effectuates operations. The operations may include sending a request to provide authorization of local communication for one or more devices to use a data service. The request can be initiated from a primary device or other requestor devices. In response to the request, displaying a list of the one or more devices that are at a location proximate to the apparatus; sending a selection of devices of the list of devices that are at the location proximate to apparatus; and based on the selection, receiving a notification that comprises confirmation of implementation of the authorization of the local communication for the selection of devices. The location proximate to the first device may be a threshold distance between the apparatus and the one or more devices. The local communication comprises access to a local private server.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrates an exemplary system for localized authorization for secure communication.

FIG. 2 illustrates an exemplary method for localized authorization for secure communication.

FIG. 3 illustrates an exemplary method for localized authorization for secure communication associated with secure home meetings.

FIG. 4 illustrates an exemplary system that may involve authentication and localization for security and communication associated with an on-demand contract (OTC).

FIG. 5 illustrates an exemplary method for authentication and localization for security and communication associated with an on-demand contract (OTC).

FIG. 6 illustrates a schematic of an exemplary network device.

FIG. 7 illustrates an exemplary communication system that provides wireless telecommunication services over wireless communication networks.

### DETAILED DESCRIPTION

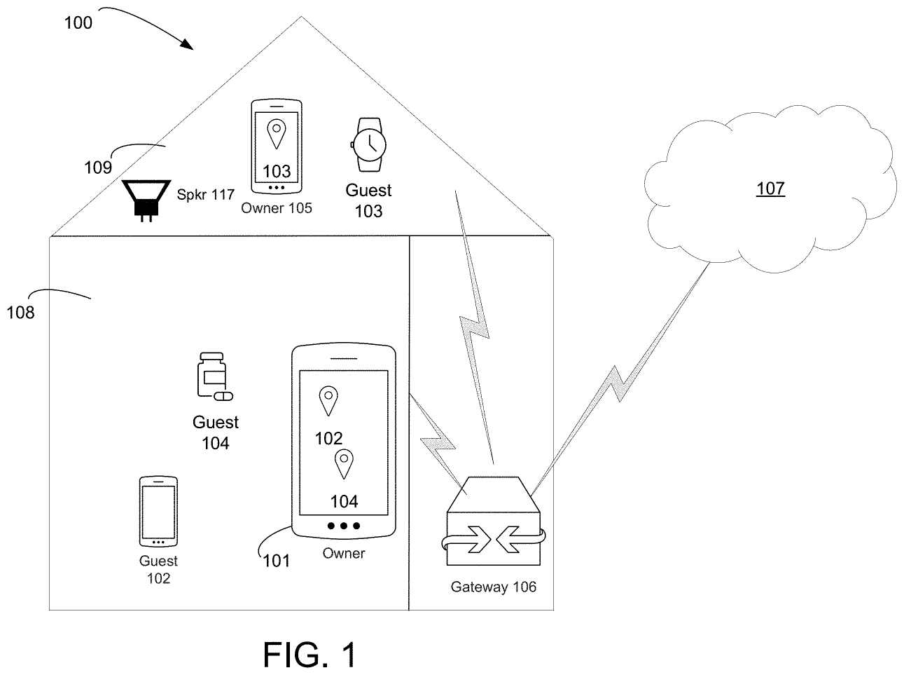

FIG. 1 illustrates an exemplary system for localized authorization for secure communication. System 100 may include multiple devices, such as owner device 101, guest device 102, or guest device 104 located in room 108. Owner device 105, smart speaker 117, and guest device 103 may be located in room 109. Gateway 106 may be a network gateway to network 107 (e.g., the Internet). In an example scenario, guest device 102 and owner device 101, 105 may be respective mobile phones, guest device 103 may be a smart watch, and guest device 104 may be a smart pill box. Guest device 103 and guest device 104 may have significantly limited input capacity (e.g., limited regarding entering usernames and passwords). The guest devices may only need to have access to gateway 106 (and therefore Internet 107) for a limited period during a visit. Owner device 101 (or owner device 105) may be a device that has credentials to access gateway 106 or provide authorization to other devices to access gateway 106. As disclosed in more detail herein, owner device 105 and owner device 101 may have authorization to permit devices in their respective rooms to access gateway 106 or use gateway 106 in certain manner (e.g., use gateway 106 but allow different types of traffic).

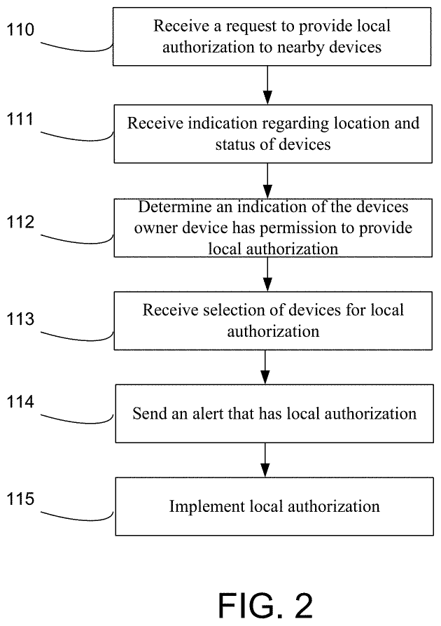

FIG. 2 illustrates an exemplary method for localized authorization for secure communication. At step 110, owner device 101 may send a request to provide local communication authorization to nearby devices (e.g., within the same room or on the same floor). Owner device 101 may be authenticated using Zenkey or a similar application.

At step 111, an indication, which may be based on the request of step 110, may be received regarding the location and status of devices within a domain of gateway 106 (e.g., communicatively connected with gateway 106) or proximate to owner device 101. Gateway 106 may determine that guest device 102, guest device 104, and owner device 101 are in room 108, while owner device 105 and guest device 103 are in room 109.

At step 112, determine by gateway 106 an indication of the devices that owner device 101 has permission to provide local communication authorization to gateway 106 (e.g., allow access to gateway 106). Based on the determination, owner device 101 may receive a message with text or graphics (e.g., a map) that lists the devices proximate to owner device 101, such as guest device 104 or guest device 102 in the same room 108 as owner device 101 or within a threshold distance between owner device 101 and guest device 104. Guest device 103 is in room 108 and therefore owner device 101 cannot provide local communication authorization, but owner device 105 may provide local communication authorization.

The local communication authorization may expire based on different factors. Factors may include expiration after a set period, when owner device 101 is no longer in the same room (e.g., any room, but the same room) as guest device 102 or guest device 104, or when owner device is no longer in the same particular room in which authorization was given (e.g., room 108), or other location. Localization technology, such as ultra-wideband communication (UWB), allows for a chip to be used to locate an object down to centimeter-level accuracy. Therefore, owner device 101 or other devices can determine that devices are nearby. In addition, expiration of local communication authorization may be based on events. For example, if guest device 102 only has local communication authorization to send a SMS message, after the event happens, then access expires.

At step 113, in response to the indication of step 112, gateway 106 may receive a message with instructions from owner device 101. The instructions may include the devices that have local communication authorization and the factors needed for authorization to remain. Table 1 provides exemplary information in the information that may be sent to gateway 106. It is contemplated that the message may indicate individual devices or a group of devices (e.g., for room 108: all smartphones, all smartwatches, all non-interface devices, or all devices in room 108). It is contemplated that such a scenario may be used for the cellular network. Table 2 provides exemplary information in a cellular context. Example resources include WIFI access, cellular access, server access, database access, or access associated with communicating using particular applications (e.g., email, web browser, SMS, etc.) through the accessed network, among others.

TABLE 1

Resource: WIFI access
Duration: One-hour and
while in room 108
Device name: Liza phone
Device ID: mac_addr 123...

TABLE 2

Resource: Cellular access
Duration: One SMS message
Device name: Liza phone
Device ID: IMEI, IMSI123...

At step 114, gateway 106 or owner device 101 may send an alert to the newly authorized devices (e.g., guest device 102 or guest device 104) depending on device's capability to receive or show alerts. The alert may include information about the duration and other factors associated with access (e.g., similar to Table 1 or Table 2). At step 115, implement the local communication authorization for the period.

With continued reference to FIG. 1 and FIG. 2, it is contemplated that guest device 102, for example, may send a request for local communication authorization, such as when attempting to connect with local Wi-Fi (e.g., gateway 106). Gateway 106 may search for and determine the closest device to guest device 102 that can permit local communication authorization (e.g., owner 101) and send a notification. The notification may include details about guest device 102 and a request for local communication authorization. Gateway 106 may subsequently send a similar notification to the next closest device (e.g., owner device 105) if owner device 101 does not respond within a certain period.

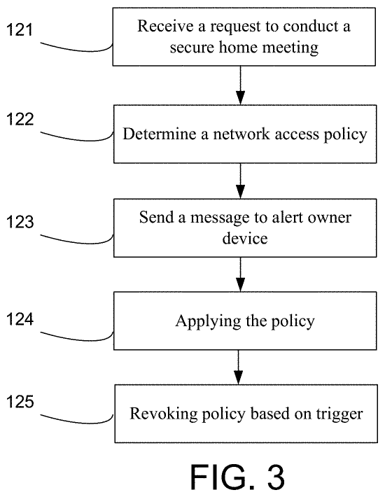

FIG. 3 illustrates an exemplary method for localized authorization for secure communication associated with secure home meetings. In a typical home or even office environment it is difficult to ascertain how many devices are listening (e.g., smart speaker 117) and watching (e.g., guest device 102), as well as connecting to the Internet. The disclosed subject matter may allow for more secure meetings.

At step 121, gateway 106 may receive a request to conduct a secure home meeting during a period. This request may be triggered by a message from owner device 101 or an electronic calendar, which indicates that a meeting will occur or is occurring. Here it may be assumed that owner 101 has authorization to control network access to one or more devices on the home network.

At step 122, based on the trigger of step 121, determine a network access policy for the period. The network access policy may be particular to each device and include duration of policy implementation, devices policy is applicable to (e.g., proximity, device ID, device types), traffic allowed (e.g., type, source, or destination), or the like. In an example, a policy may include no social media, no cameras, and no recording. In this example, network access for devices with such capabilities may be denied entirely or partially (e.g., deny traffic that specifically matches the policy). The policy may be already present on gateway 106 or downloaded (e.g., from owner device 101 or another device or the cloud/Internet). In another example, the policy may be associated with the proximity to owner 101. Devices in the same room (e.g., room 108) as owner device 101 may have the policy applicable to them, but not to devices in other rooms (e.g., room 109).

At step 123, send a message to alert owner device 101 device or devices affected by the policy. At step 124, applying the policy of step 122 by owner device 101 or gateway 106. At step 125, based on detecting a second trigger (e.g., duration or location, among other things), revoking some or all of the policy or changing the policy for the one or more devices affected by the policy. Revoking policy may include allowing all access to network 107. In another example, each room may have its own policy, therefore if guest device 102 moves to room 109 from room 108 another (maybe less restrictive) policy may be put into place.

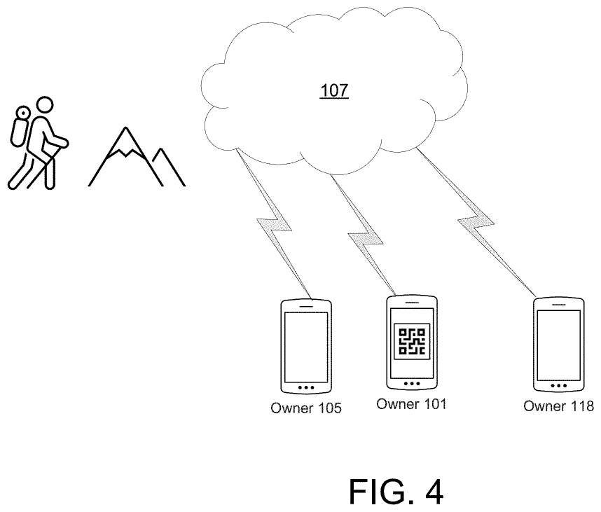

FIG. 4 illustrates an exemplary system that may involve authentication and localization for security and communication associated with an on-demand contract (OTC). In an example scenario, a group of friends (owner device 101, owner device 105, and owner device 118) go on a hiking trip. They all may have Zenkey or a similar application and have service with 3 different carriers. It is likely that at different points one carrier has acceptable service and one or more of the other carriers may have unacceptable service during different parts of the trip. The disclosed system may help make sure that all of the devices have acceptable connections during most of the trip.

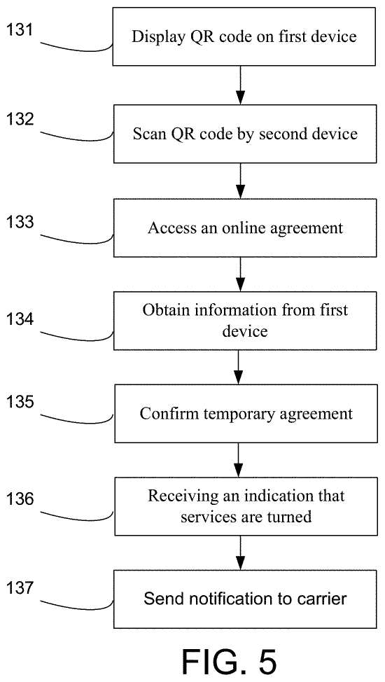

FIG. 5 illustrates an exemplary method for authentication and localization for security and communication associated with an on-demand contract (OTC). In this scenario, owner device 101 has acceptable service and owner device 105 or owner device 118 has unacceptable service (e.g., unable to make call or web surf). It is contemplated that the devices have the hardware needed to operate on another carrier. At step 131, owner device 101 may go to a website or an app which provides services for one-demand contract and retrieves a QR code or the like on its screen. Device 101 will authenticate itself with the service via the QR code or the like. At step 132, owner device 105 (with a first carrier) scans the same QR code of owner device 101 (with a second carrier) to authenticate with the service too. At step 133, in response to scanning the QR code at step 132, accessing an online agreement for the second carrier. The online agreement may be a temporary agreement that may last hours, days, or another set duration. At step 134, the system of the second carrier may obtain information from owner device 105 or directly from the one-time contract service website or app, such as the information in Table 3.

TABLE 3
Devices: Phone number: 1234567890
Service Duration: Start: Jan. 7, 2021 and End: May 7, 2021
Location: Utah, California
Resources: Voice, Data, SMS
Split method: By usage or 50/50

At step 135, sending, by owner device 105, a confirmation of the temporary agreement for wireless service from the second carrier. At step 136, receiving an indication that services are turned on for owner 105 from the second carrier. At step 137, a notification may be sent to the first carrier of owner device 105. The notification may be used to alert the first carrier of the temporary switch in service. The first carrier may reconfigure its network to accommodate the use of the second carrier network. Similar to roaming, the bills can be generated based on the usage and shared across carriers if needed. The contract may be terminated on-demand, based on location, or duration of the agreement, among other things.

The aforementioned system of FIG. 5 may be used in several different scenarios. In a scenario, a user possesses owner device 101 which may be connected with a first carrier and owner device 105 (e.g., a tablet computer) which may not be connected yet. The reason may be because the user usually has access to Wi-Fi and usually doesn't need to connect with the first carrier. At some point (e.g., during a commute), the user may use the steps of FIG. 5 in order to activate owner device 105 on the first carrier. In another scenario, the process of FIG. 5 may be used in urgent situations in which there is a desire for a quick setup. For example, if a first user of owner device 105 wants to borrow owner device 118 from a second user, but still be on the same carrier and phone plan, the process may be used to obtain (temporarily) the configuration of the first user device (owner device 105), which may be started by QR code or the like, and configure the second user device (owner device 118). This may help to streamline billing while using different mobile devices. In the examples provided herein the method steps may be executed in one device or distributed over multiple devices.

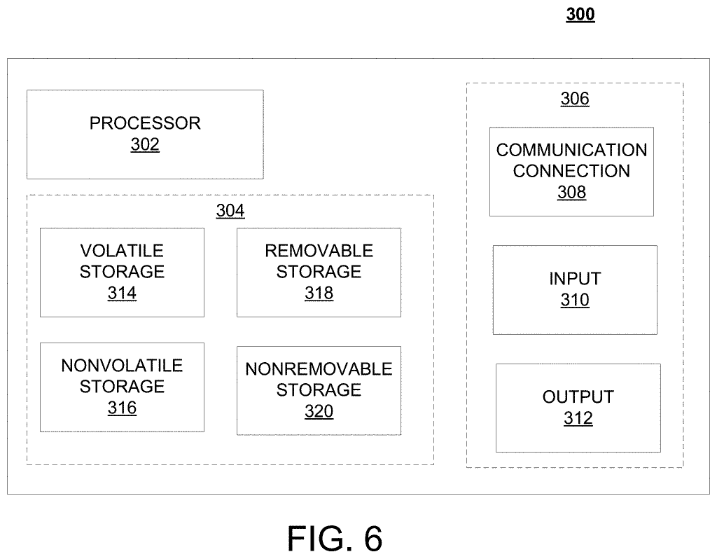

FIG. 6 is a block diagram of network device 300 that may be connected to or comprise a system 100. Network device 300 may comprise hardware or a combination of hardware and software. The functionality to facilitate telecommunications via a telecommunications network may reside in one or combination of network devices 300. Network device 300 depicted in FIG. 6 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 6 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength.

In addition to processor 302 and memory 304, network device 300 may include an input/output system 306. Processor 302, memory 304, and input/output system 306 may be coupled together (coupling not shown in FIG. 6) to allow communications between them. Each portion of network device 300 may comprise circuitry for performing functions associated with each respective portion. Thus, each portion may comprise hardware, or a combination of hardware and software. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

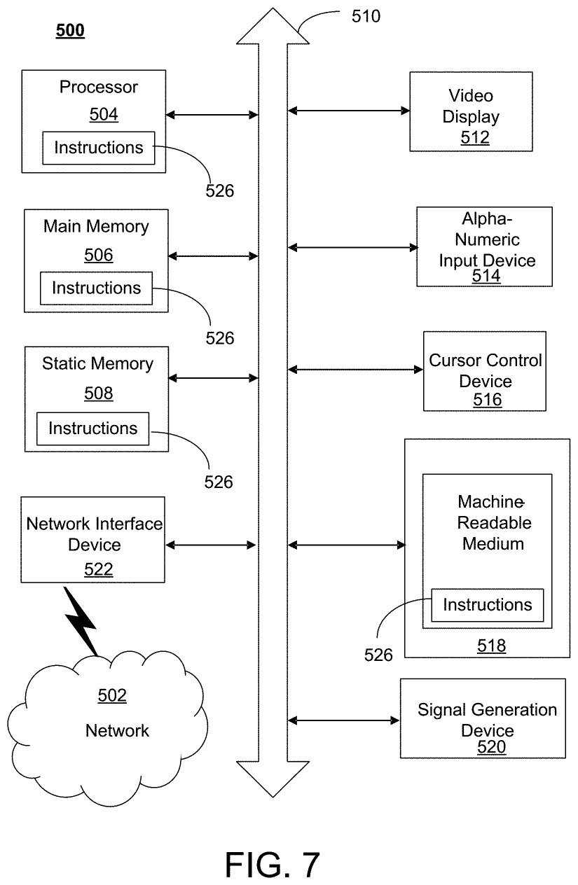

FIG. 7 depicts an exemplary diagrammatic representation of a machine in the form of a computer system 500 within which a set of instructions, when executed, may cause the machine to perform any one or more of the methods described above. One or more instances of the machine can operate, for example, as processor 302, owner device 101, owner device 105, speaker 117, gateway 106, and other devices of FIG. 1. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

As described herein, a telecommunications system may utilize a software defined network (SDN). SDN and a simple IP may be based, at least in part, on user equipment, that provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a system in which localized authorization for secure communication alerts can be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes a device for implementing telecommunications as described herein. When implemented on a general-purpose processor, the program code combines with the processor to provide a unique device that operates to invoke the functionality of a telecommunications system.

While the disclosed systems have been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—localized authorization for secure communication—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

Methods, systems, and apparatuses, among other things, as described herein may provide for localized authorization for secure communication. A method, system, computer readable storage medium, or apparatus provides for sending, by a first device, a request to provide authorization of local communication for one or more devices to use a data service; in response to the request, displaying a list of the one or more devices that are at a location proximate to the first device; sending a selection of devices of the list of devices that are at the location proximate to the first device; and based on the selection, receiving a notification that comprises confirmation of implementation of the authorization of the local communication for the selection of devices. The location proximate to the first device may be a threshold distance between the first device and the one or more devices or a particular room. The local communication comprises access to a local private server. A device may request resources on behalf of one or more devices upon successful authentication by itself. A system can provide a one-time or temporary agreement after multiple devices agree on a contract upon authenticating with the network. All combinations in this paragraph (including the removal or addition of steps) are contemplated in a manner that is consistent with the other portions of the detailed description.

1. A method comprising:
sending, by a first device, a request to provide authorization of local communication for a data service;
based on the sending of the request, displaying, by the first device, a list of the-one or more devices that are at a location proximate to the first device;
sending, by the first device and based on the displaying, a selection of at least one device included in the one or more devices, wherein the selection includes instructions that specify at least one resource of a network that the at least one device may access as part of the authorization of local communication; and
based on the sending of the selection, receiving, by the first device, a notification that comprises a confirmation of an implementation of the authorization of the local communication for the at least one device.

2. The method of claim 1, wherein the location proximate to the first device is a threshold distance between the first device and the one or more devices.

3. The method of claim 1, wherein the location proximate to the first device is a same room as the first device.

4. The method of claim 1, wherein the local communication comprises access to the Internet.

5. The method of claim 1, wherein the local communication comprises access to a local private server.

6. The method of claim 1, wherein the request is associated with a one-time contract request.

7. The method of claim 1, wherein the local communication comprises communicating via an application type, wherein the application type is electronic mail.

8. A first device comprising:
a processor; and
memory coupled with the processor, the memory storing executable instructions that when executed by the processor cause the processor to effectuate operations comprising:
sending a request to provide authorization of local communication for a data service;
based on the sending of the request, displaying a list of one or more devices that are at a location proximate to the first device;
sending, based on the displaying, a selection of at least one device included in the one or more devices, wherein the selection specifies a duration of the authorization of local communication for the data service that is to be granted to the at least one device; and
based on the sending of the selection, receiving a notification that comprises a confirmation of an implementation of the authorization of the local communication for the at least one device.

9. The first device of claim 8, wherein the location proximate to the first device is a threshold distance between the first device and the one or more devices.

10. The first device of claim 8, wherein the location proximate to the first device is a same room as the first device.

11. The first device of claim 8, wherein the local communication comprises access to the Internet.

12. The first device of claim 8, wherein the local communication comprises access to a local private server.

13. The first device of claim 8, wherein the local communication comprises communicating via an application type.

14. The first device of claim 8, wherein the local communication comprises communicating via an application type, wherein the application type is electronic mail.

15. A computer-readable storage medium storing computer executable instructions that when executed by a computing device cause said computing device to effectuate operations comprising:
receiving a request from a first device to provide authorization of local communication;
based on the receiving of the request, determining that the first device and a second device are located in a first room;
based on the determining that the first device and the second device are located in the first room, providing the first device with a first message that identifies the second device;
based on the providing of the first message, receiving a second message from the first device that authorizes the second device for the local communication while the first device is in the first room;
based on the receiving of the second message, implementing the local communication involving the second device;
subsequent to the implementing, determining that the first device is located in a second room that is different from the first room; and
based on the determining that the first device is located in the second room, causing the local communication involving the second device to expire.

16. (canceled)

17. The computer-readable storage medium of claim 15, wherein the local communication comprises access to the Internet.

18. The computer-readable storage medium of claim 15, wherein the local communication comprises access to a local private server.

19. (canceled)

20. (canceled)

21. The computer-readable storage medium of claim 15, wherein the operations further comprise:
based on the receiving of the second message, transmitting an alert to the second device that includes information about access by the second device to the local communication.

22. The computer-readable storage medium of claim 21, wherein the operations further comprise:
causing the first device to transmit the alert.

23. The method of claim 1, wherein the instructions that specify at least one resource of the network that the at least one device may access as part of the authorization of local communication comprise an indication of: WIFI access, cellular access, server access, database access, and access associated with communicating using an email application, a web browser, and SMS.
